(19) United States
(12) Patent Application Publication
(10) Pub. No.: US 2015/0191227 A1
(43) Pub. Date: Jul. 9, 2015

(54) SKEG SYSTEM FOR STAND-UP PADDLEBOARDS AND OTHER WATER CRAFT

(71) Applicant: Corran D Addison, Capistrano Beach, CA (US)

(72) Inventor: Corran D Addison, Capistrano Beach, CA (US)

(21) Appl. No.: 14/590,099

(22) Filed: Jan. 6, 2015

Related U.S. Application Data
(60) Provisional application No. 61/924,456, filed on Jan. 7, 2014.

(51) Int. Cl. B63B 35/79; F16M 13/02

(52) U.S. Cl. CPC B63B 35/7926; F16M 13/02

(57) ABSTRACT

A system for effectively assisting tracking and steering of stand-up paddleboard and other water craft. Particularly, the present application provides a skeg system that allows a user of a stand-up paddleboard to steer the stand-up paddleboard. The system allows the skeg to automatically lift up and away from any submerged objects it may run into when it contacts them, wherein after the object has passed under the stand-up paddleboard, the skeg moves back into position in the water to provide further steering assistance. The skeg system also includes a cord system by which the user can quickly and easily remove the skeg from the water to clear kelp, seaweed, or other debris from it.

### CROSS REFERENCE

The present application claims priority to Provisional Patent Application Ser. No. 61/924,456, filed 7 Jan. 2014, the disclosures of which are hereby incorporated herein by reference.

### TECHNICAL FIELD

The present invention relates to the field of stand up paddleboards, particularly to the attachments or modifications and more particularly a skeg system in the deck of paddleboards for tracking or steering a stand up paddleboard with additional potential applications to other water crafts.

### BACKGROUND

The sport of stand-up paddleboarding goes back to ancient Hawaii—the birthplace of not only surfing but also stand-up paddleboarding. Stand-up paddleboarding is one of the most versatile sports in the world, as it combines some of the best characteristics of kayaking, canoeing, surfing, and a gym in one board and a paddle. This versatility allows the Stand-up paddleboard user to use the Stand-up paddleboard for a variety of purposes. However, a problem that the average user of a Stand-up paddleboard encounters is that no matter where the stand-up paddleboard paddler is paddling, he/she must try to control the direction of the stand-up paddleboard.

The user controls the direction of the stand-up paddleboard in various ways. For example, the user can exert some control over the stand-up paddleboard by paddling harder or more often on one side of the stand-up paddleboard, or using a different type of paddling stroke on one side. The user can also turn the craft by putting more weight on one side than the other. However, there are situations when the user would prefer to use some sort of rudder system to turn, or control the tracking, of a stand-up paddleboard. While there are traditional means of steering, including fins fixed to the bottom of watercraft, including surfboards and stand-up paddleboards, and skegs removable from the water in sea kayaks, none can accommodate the additional need for a directional control device that won't break off should it hit a rock, log, or other hard object in a river, lake or ocean.

The existence of surfboard fins is well known in the art. These fins are fixed to the underside of surfboards, stand-up paddleboards and kayaks. These fins are not easily removable at the whim of the user, and can break off when the water craft strike a submerged object. Indeed, when one of these fins break off, the entire water craft may be compromised, as fins are usually either adhered with fiberglass or a similar compound to the bottom of the craft (in such cases when hitting a submerged object the entire portion of the water craft can be ripped away), or inserted into fin boxes which are embedded into cavities drilled or routed into the underside of the water craft (in such cases the entire fin box and surrounding surface of the water craft can be ripped away).

Another problem with such surfboard fins is that they may be a cause of injury to other surfers, when one surfer riding a wave accidentally (in most cases) runs over another surfer. Because these fins are non retractable, the fins behaves as a blunt butcher knife attached to the side of a bicycle being ridden around at full speed through a crowd of people.

Of further concern is that in both surfing and river running, the stand-up paddleboard rider often travels at 10-20 mph, a high speed at which a collision with another rider proof dangerous, such high speed gives the rider very little time to adjust the course of the stand-up paddleboard to avoid any obstacle. Thus, the more solidly the fins attached to the water craft, the more damage is likely to occur to both the water craft and any person to whom it hits.

Further, sea kayak skegs are also well known in the art. Sea kayaks have “flip-up” skegs, but they do not seem to have adequate turning ability to function well with a stand-up paddleboard. They also do not have a mechanism by which they can “bounce” off a rock, leave the water until the rock or other submerged object passes under the stand-up paddleboard, and then reenter the water and continue to provide steering ability.

Further, a frequent problem that stand-up paddleboard users run into when paddling their stand-up paddleboards in bays or oceans is that the skeg often traps kelp and other marine debris in front of its leading edge, thereby slowing down the kayak. While the user can flip up the skeg to remove the debris, he/she must then flip the skeg back down after the kelp has drifted behind the skeg.

Existence of embedded fin box systems with the watercrafts is well known in the art. Some water crafts use lengthy, embedded fin systems that are either molded into, or embedded after manufacture, into the bottom thereof. Use of such fin box systems add heaviness adding undesirable weight to the water craft, and because they are an integral part of the water craft, any damage to the fin likely creates damage to the fin box and the underside of the water craft.

Thus there has existed a long-felt need for a skeg system for paddleboards that will allow the user of a stand-up paddleboard to steer the stand-up paddleboard, and that won't break off and rip away half the hull when the stand-up paddleboard strike a rock or other underwater obstruction during surfing, river running or just regular paddling, and is easily lifted and re-inserted into the water to clear kelp, seaweed and other floating debris. It is also desirable to have a steering invention that when the invention is damaged, it will not tear away part of the water craft it is used to steer, and it can easily be removed and repaired/replaced with easy-to-install parts.

Thus, in the light of the above mentioned background art, it is also evident that, there is a need for a skeg system that is designed to attach to the stern of a stand-up paddleboard, where the skeg can be rotated, and lowered or raised by the user per user's will. There is also a need for a mechanism that enables a user to effectively steer the paddleboard using a rotatable vertical blade in the water that not only controls the user for rotation but also provides an ability to the skeg to bounce away from rocks and other debris upon contact and re-engage the water for further steering.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

The present invention comprises of a skeg that provides an effective steer on a stand-up paddleboard using a rotatable vertical blade in the water. In an embodiment, the skeg is mounted to the stern of a stand up paddleboard either by its own weight, by a bungee cord, a spring or other elastic device. Further, the skeg is connected to the mounting bracket at various possible locations. The skeg is easily inserted into the water and is rotated under the direction of the paddler.

The invention further comprises of a cord system which allows the user to quickly and easily flip up the skeg to distangle kelp, seaweed and other debris caught during paddling. The system not only controls the user for rotation but also provides an ability to bounce away from rocks and other debris upon contact and re-engage the water for further steering.

The present invention further provides a steering mechanism for standup paddleboard and other water crafts that prevents the chances of breakage of both the steering mechanism and the water craft. Moreover, the steering mechanism also provides easy replacement of damaged parts by easy and quick removal and replacement of repaired parts from the water craft.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the present invention, reference is now made to the following descriptions taken in conjunction with the accompanying drawing, in which:

FIG. 1 illustrates the side view of a skeg using a bungee cord or other elastic device to removably retain the skeg in the water, according to an exemplary embodiment of the invention;

FIG. 2 illustrates the side view of a skeg according to other form of invention using other elastic device to removably retain the skeg in the water, according to an exemplary embodiment;

FIG. 3 illustrates the side view of skeg using a spring to removably retain the skeg in the water, according to an exemplary embodiment;

FIG. 4 illustrates the side view of skeg with a mounting bracket attached to the top of the stern of the stand-up paddleboard, according to an exemplary embodiment;

FIG. 5 illustrates the top view showing the location of skeg and mounting bracket, according to an exemplary embodiment;

FIG. 6 illustrates the side view of the skeg with its natural position in water allowing the skeg to temporarily lift up to, and in some cases above, the surface of the water when it comes into contact with a submerged object such as a rock, coral reef, seaweed or log, to an exemplary embodiment; and

FIG. 7 illustrates the perspective view of the skeg, according to an exemplary embodiment.

### DETAILED DESCRIPTION OF THE FIGURES

The following detailed description illustrates by way of example and not by way of limitations.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

In the disclosure herein, consideration or use of a particular element number in a given figure. or corresponding descriptive material can encompass the same, an equivalent, or an analogous element number identified in another figure. or descriptive material corresponding thereto.

Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

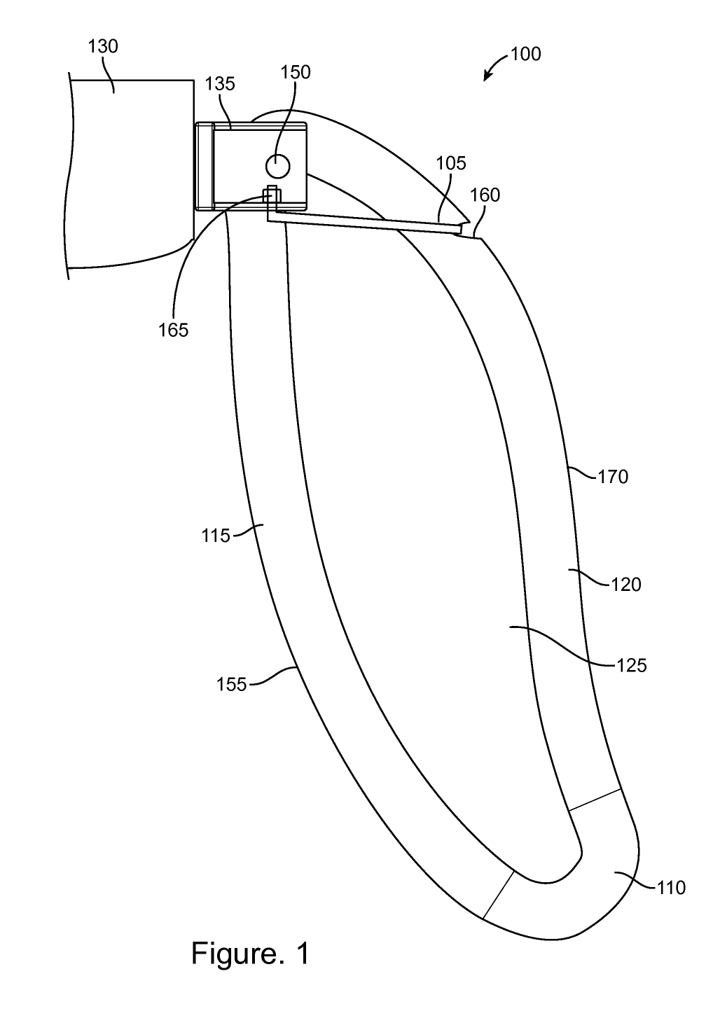

FIG. 1 illustrates the side view of a skeg 100 using a bungee cord 105 or other elastic device to removably retain the skeg in the water. The skeg 100 comprises of tip 110, a leading edge 115, a trailing edge 120 and a central position 125. The skeg 100 is further attached to the stern 130 of a stand-up paddleboard (although the use of skeg with other water craft is contemplated and the figures and descriptions herein should not be construed to limiting this invention to just stand-up paddleboards). The skeg 100 is attached to the stern 130 with the mounting bracket 135.

Further, the mounting bracket 135 comprises of a rear-mounted mounting bracket 140 which comprises of a cavity 145 into which part of the skeg 100 fits. The skeg 100 is attached to the rear-mounted mounting bracket 140 by a cottor pin 150 or other means of attachments i.e., pop rivet, screws or other types of attachment.

The skeg 100 is situated at a natural position 155 which is determined by the force applied to the skeg 100 through a bungee cord 105 that stretches from a notch 160 in the skeg 100 to an attachment point 165 in the mounting bracket 135. The skeg 100 when hits a rock or other hard or substantial obstruction bounces up off the obstruction toward a raised position 170 instead of shattering or ripping off part of the bottom of the stand-up paddleboard. The skeg 100 returns to the natural position 155 with the help of the bungee cord 105.

Moreover, the device comprises of an optional cord system by which the user can easily and quickly raise the skeg 100 from natural position 155 to a raised position 170 to clear floating seaweed and other light-weight debris from the skeg 100. Further in case of any damage to the skeg 100 by sideway collision, the key parts wherein the skeg 100, mounting bracket 135 and the cotter pin 150 are replaced with the replacement part. The damage caused in the device will not destroy the entire watercraft and can be easily fixed such that the water craft is back in water quickly.

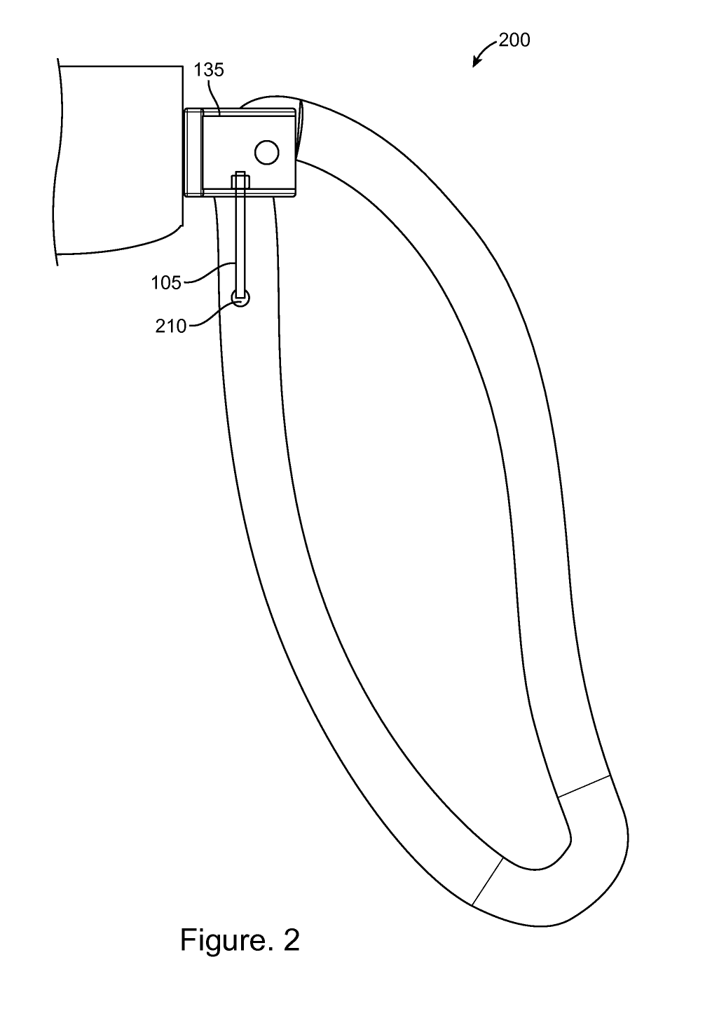

FIG. 2 illustrates the side view of the skeg 100 comprising of an elastic device 205 holding the skeg from below to removably retain the skeg in the water. The skeg comprises of the bungee cord 105 running from the leading edge attachment point 210 to the mounting bracket 135. Further, in this embodiment, more than one bungee cord 105 is contemplated and connections between the skeg and the mounting bracket 135 at different locations are also contemplated.

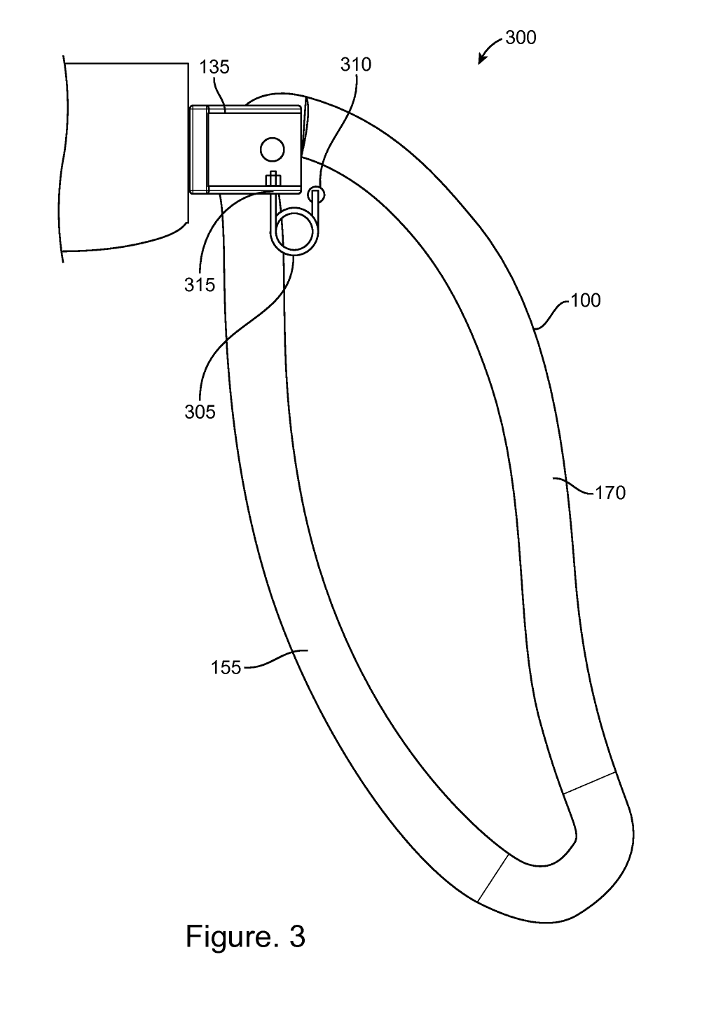

FIG. 3 illustrates the side view of a skeg 100 comprising of a spring 305 to removably retain the skeg in the water. The spring 305 is connected to the skeg 100 to the mounting bracket 135 from a skeg centre attachment point 310 to a spring bracket attachment point 315 on the mounting bracket. Further, when the skeg passes over a rock, the skeg is flipped towards a raised position 170. Once it has passed over the rock, the spring 305 applies pressure wherein the skeg returns to its natural position 155.

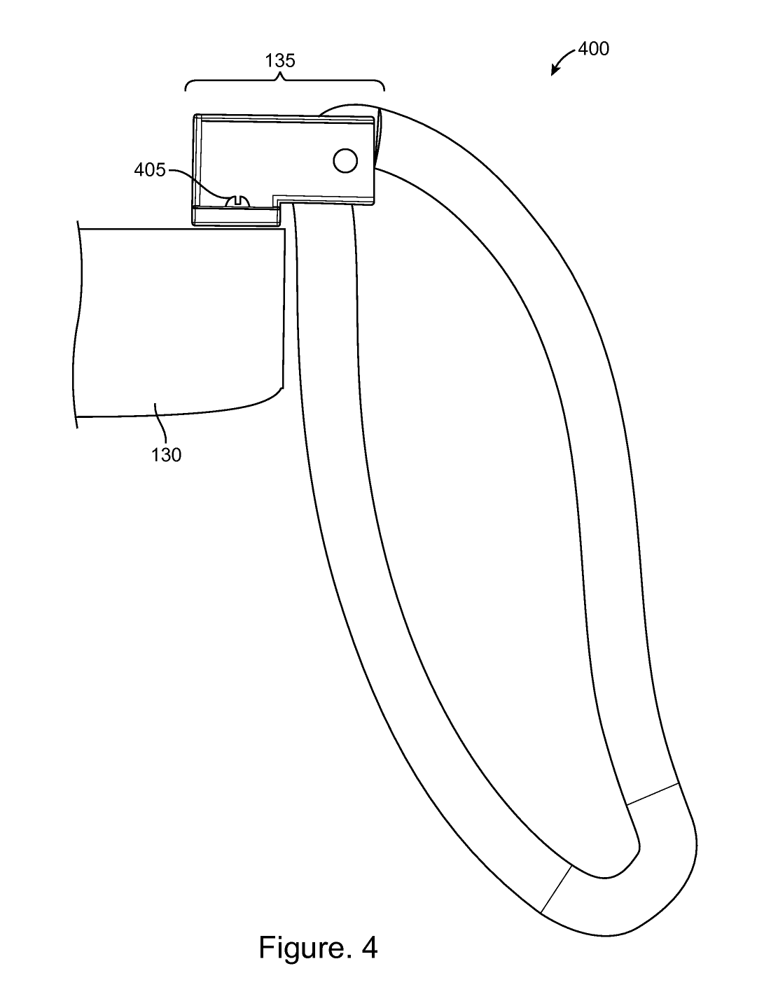

FIG. 4 illustrates the side view of skeg with a mounting bracket 135. Herein, the mounting bracket 135 is attached to the top of the stern 130 of the stand-up paddleboard. Further, the mounting bracket 135 comprises of a means of attachment 405 wherein consist of a screw, pop rivet or other types of attachment

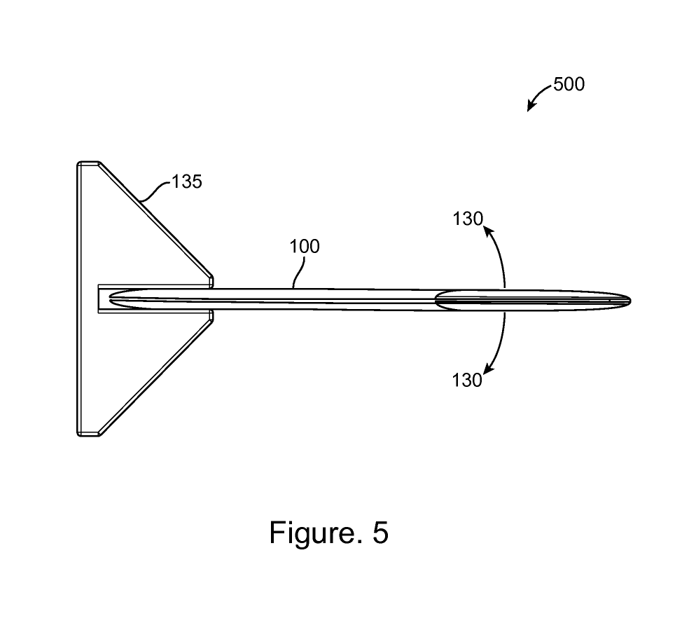

FIG. 5 illustrates the top view of the device showing the location of the skeg and the mounting bracket 135. The mounting bracket 135 comprises of a cavity 145 wherein the skeg is fitted into the cavity whereby restrains the skeg from undesired sideway movements.

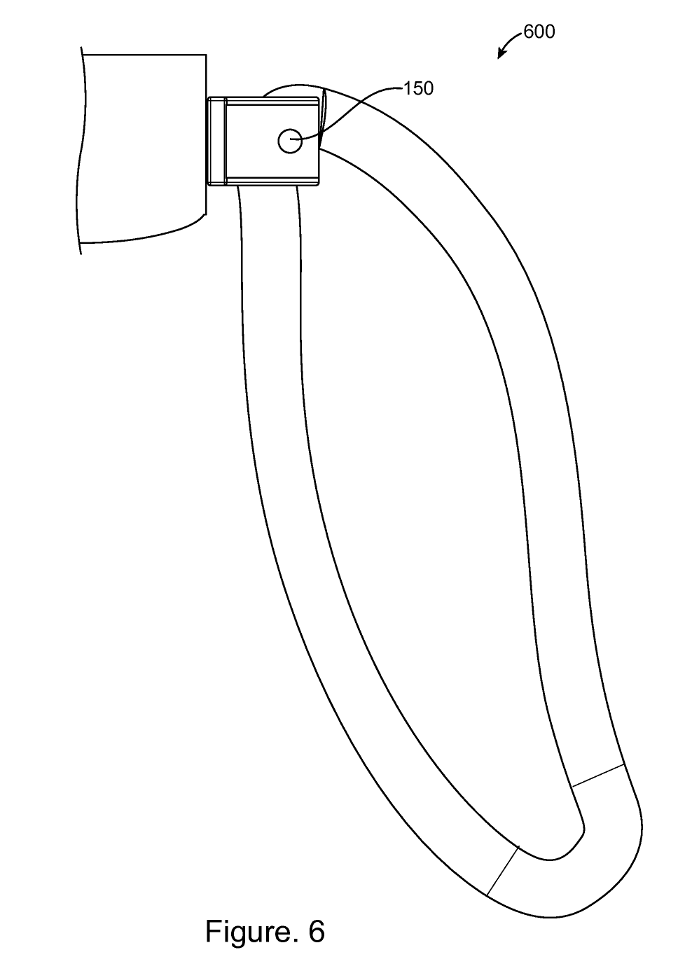

FIG. 6 illustrates the side view of skeg without the use of bungee. The skeg 100 without the use of bungee keeps the weight of skeg down into the water. Moreover, the skeg 100 can be kept down in place by replacing the cotter pin 150 with a locking mechanism whereby it is permanently in the water and cannot rotate up.

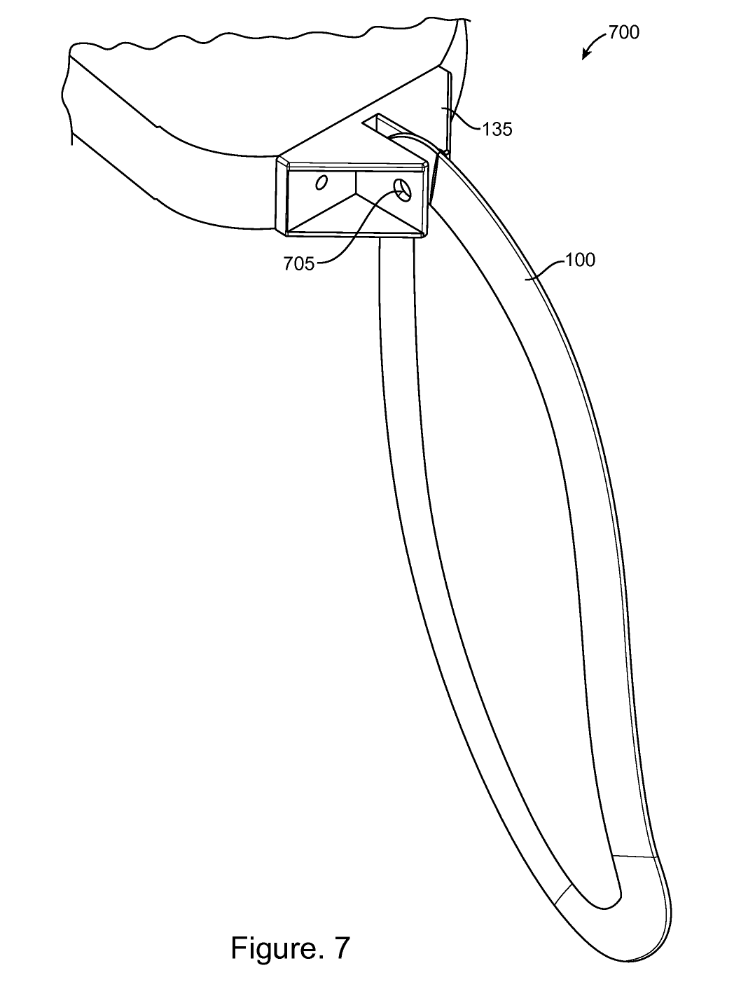

FIG. 7 illustrates the perspective view of the skeg 100. The mounting bracket 135 comprises of a hole 705, wherein the skeg 100 fits into a cavity 145 in the mounting bracket 135. The mounting bracket 135 and the skeg 100 comprises of a hole 705 through which a cotter pin 150, bolt or other means of connection and retention can be used.

The examples described above in association with the figures are only exemplary and the skeg system for stand-up paddleboard can be custom made. The skeg system for stand-up paddleboard can be applied to designs and sizes differing from what are shown in the figures.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims the invention. It should also be specifically noted that the descriptions herein relating to how a skeg system can have a natural position in the water and yet be temporarily moved in an upward manner may also have applicability to any watercraft. It is also contemplated that the skeg, because it is so easily removable from the stand-up paddleboard, could have additional uses, such as an eating plate, a sea urchin spine remover, or even as a weapon or boomerang used for the hunting of animals in the event that the user of the stand-up paddleboard becomes lost and must “live off the land” for a significant time period.

It should be recognized that while the above description focused on the use of device in accordance to paddleboard, these description may also be used in utilizing the device in conjunction with other watercrafts.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosures as would be understood by those in ordinary skilled in the art.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

I claim:

1. A system for effectively assisting tracking and steering of stand-up paddleboard and other water craft, the system comprising of;
a skeg;
a mounting bracket; and
a means of constraint.
wherein the skeg is attached with the mounting bracket and is removably constrained in a natural position by means of constraint.

2. A system for effectively assisting tracking and steering of stand-up paddleboard and other water craft as claimed in claim 1, wherein the said mounting bracket is attached to the rear end of a stern section of a stand-up paddleboard.

3. A system for effectively assisting tracking and steering of stand-up paddleboard and other water craft as claimed in claim 1, wherein the said mounting bracket is attached to the top of a stern section of a stand-up paddleboard.

4. A system for effectively assisting tracking and steering of stand-up paddleboard and other water craft as claimed in claim 1, wherein the said means of constraint is an elastic cord.

5. A system for effectively assisting tracking and steering of stand-up paddleboard and other water craft as claimed in claim 1, wherein the said means of constrainy is a spring.

6. A system for effectively assisting tracking and steering of stand-up paddleboard and other water craft as claimed in claim 1, wherein the skeg comprises of additional weight to maintain the skeg in the water.

7. A system for effectively assisting tracking and steering of stand-up paddleboard and other water craft as claimed in claim 1, wherein the skeg is heavy to naturally fall back into the water after striking an obstruction.

8. A system for effectively assisting tracking and steering of stand-up paddleboard and other water craft as claimed in claim 1, wherein the skeg comprises a means to secure one end of the means of constraint.

9. A system for effectively assisting tracking and steering of stand-up paddleboard and other water craft as claimed in claim 1, wherein the mounting bracket comprises means to secure the other end of the means of constraint.

10. A system for effectively assisting tracking and steering of stand-up paddleboard and other water craft as claimed in claim 1, wherein the skeg comprises means to raise and lower through manual application of force to one or more cords.

11. A system for effectively assisting tracking and steering of stand-up paddleboard and other water craft as claimed in claim 1, wherein the skeg comprises means to move from side to side thereby steering the stand-up paddleboard.
